(19) United States
(12) Patent Application Publication
(10) Pub. No.: US 2020/0290357 A1
(43) Pub. Date: Sep. 17, 2020

(54) INK JET HEAD AND INK JET PRINTER

(71) Applicant: TOSHIBA TEC KABUSHIKI KAISHA, Tokyo (JP)

(72) Inventor: Masashi SEKI, Sunto Shizuoka (JP)

(21) Appl. No.: 16/781,471

(22) Filed: Feb. 4, 2020

(30) Foreign Application Priority Data
Mar. 13, 2019 (JP) 2019-045827

(51) Int. Cl. B41J 2/165

(52) U.S. Cl. CPC B41J 2/165; B41J 2002/14258

(57) ABSTRACT

An ink jet head includes a piezoelectric member, a plurality of electrodes, a protective lamination layer, and a nozzle plate. The piezoelectric member has a plurality of grooves. The electrodes are provided along surfaces of the grooves. The protective lamination layer covers the electrodes. The nozzle plate is on the piezoelectric member and has a plurality of ejection nozzles that faces the plurality of grooves. The protective lamination layer includes an insulating layer and a first oxide layer laminated on each other. The insulating layer contains an organic material. An oxygen content of the first oxide layer is greater than an oxygen content of the insulating layer.

### CROSS-REFERENCE TO RELATED APPLICATION

This application is based upon and claims the benefit of priority from Japanese Patent Application No. 2019-045827, filed on Mar. 13, 2019, the entire contents of which are incorporated herein by reference.

### FIELD

Embodiments described herein relate generally to an ink jet head and an ink jet printer.

### BACKGROUND

An ink jet printer having a so-called shear mode type ink jet head structure in which ink droplets are ejected from nozzles by utilizing shear deformation of a piezoelectric member is known. In such a structure, for example, an insulating layer may be formed on electrodes to insulate the electrodes from ink having electrical conductivity or the like.

As an insulating material, for example, a film made of polyparaxylylene (Parylene® is known. When such an insulating material is formed by depositing polyparaxylylene after pretreating a surface of a support with a silane coupling agent, high adhesion can be obtained.

### DESCRIPTION OF THE DRAWINGS

FIG. 1 illustrates a perspective view of an ink jet head according to an embodiment.

FIG. 2 illustrates an exploded perspective view of an actuator plate, a frame, and a nozzle plate included in the ink jet head according to the embodiment.

FIG. 3 illustrates a partially cut top view of the ink jet head according to the embodiment.

FIG. 4 illustrates a cross-sectional view along a plane perpendicular to a Y-axis in FIG. 3, illustrating a part of the ink jet head according to the embodiment.

FIG. 5 is a schematic diagram illustrating an ink jet printer according to an embodiment.

FIG. 6 is a graph illustrating an example of a relationship of a leakage current value of the electrode protective film to the number of times the voltage pulse is applied.

FIG. 7 is a graph illustrating another example of the relationship of the leakage current value of the electrode protective film to the number of times the voltage pulse is applied.

### DETAILED DESCRIPTION

Example embodiments provide an ink jet head having excellent insulation durability and an ink jet printer equipped with such an ink jet head.

In general, according to an embodiment, an ink jet head includes a piezoelectric member, a plurality of electrodes, a protective lamination layer, and a nozzle plate. The piezoelectric member has a plurality of grooves. The electrodes are provided along surfaces of the grooves. The protective lamination layer covers the electrodes. The nozzle plate is provided on the piezoelectric member and having a plurality of ejection nozzles that faces the plurality of grooves. The protective lamination layer includes an insulating layer and a first oxide layer laminated on each other. The insulating layer contains an organic material. An oxygen content of the first oxide layer is greater than an oxygen content of the insulating layer.

According to another embodiment, an ink jet printer is provided. The ink jet printer includes an ink jet head according to an embodiment and a medium holding mechanism. The medium holding mechanism holds the recording medium facing the ink jet head.

### 1. Ink Jet Head

### 1-1. Configuration

Hereinafter, example embodiments will be described with reference to the drawings.

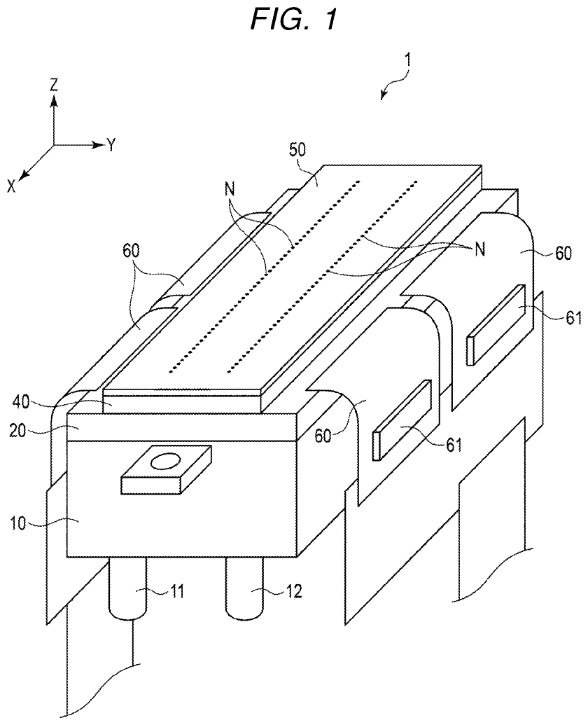

FIG. 1 illustrates a perspective view of an on-demand type ink jet head 1 to be mounted on a head carriage of an ink jet printer according to an embodiment. In the following description, an orthogonal coordinate system including an X-axis, a Y-axis, and a Z-axis is used. The X-axis direction corresponds to a print width direction. The Y-axis direction corresponds to a direction in which a recording medium is conveyed. The Z-axis direction is a direction facing towards a surface of the recording medium.

In FIG. 1, the ink jet head 1 includes an ink manifold 10, an actuator plate 20, a frame 40, and a nozzle plate 50.

The actuator plate 20 has a rectangular shape with a longitudinal direction along the X-axis direction. Examples of the material of the actuator plate 20 include alumina (Al₂O₃), silicon nitride (Si₃N₄), silicon carbide (SiC), aluminum nitride (AlN), and lead zirconate titanate (PZT: Pb(Zr,Ti)O₃).

The actuator plate 20 is overlaid on the ink manifold 10 so as to close an open end of the ink manifold 10. The ink manifold 10 is connected to an ink cartridge via an ink supply pipe 11 and an ink return pipe 12.

The frame 40 is attached on the actuator plate 20. The nozzle plate 50 is attached on the frame 40. A plurality of nozzles N is provided on the nozzle plate 50 at predetermined intervals along the X-axis direction so as to form two rows along the Y-axis.

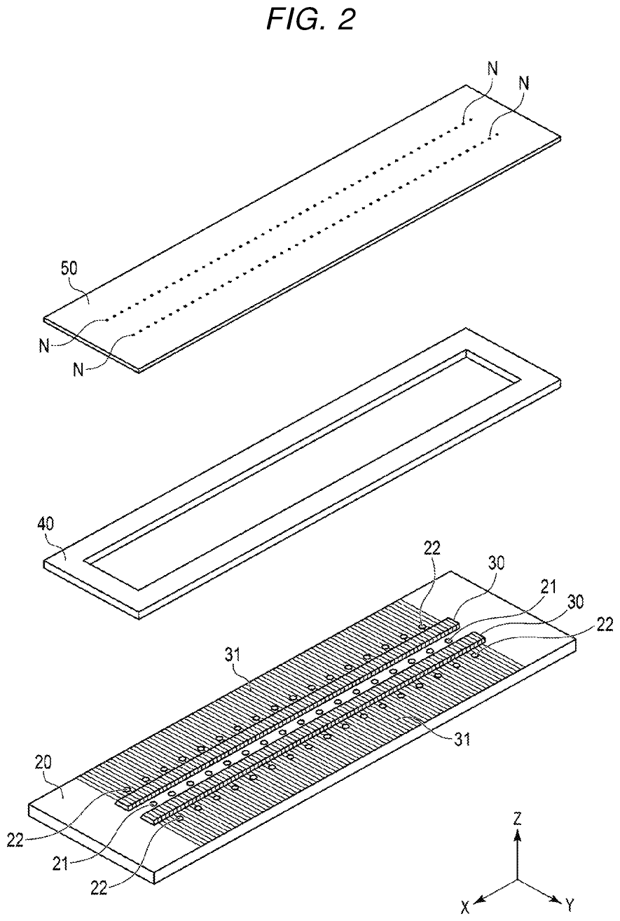

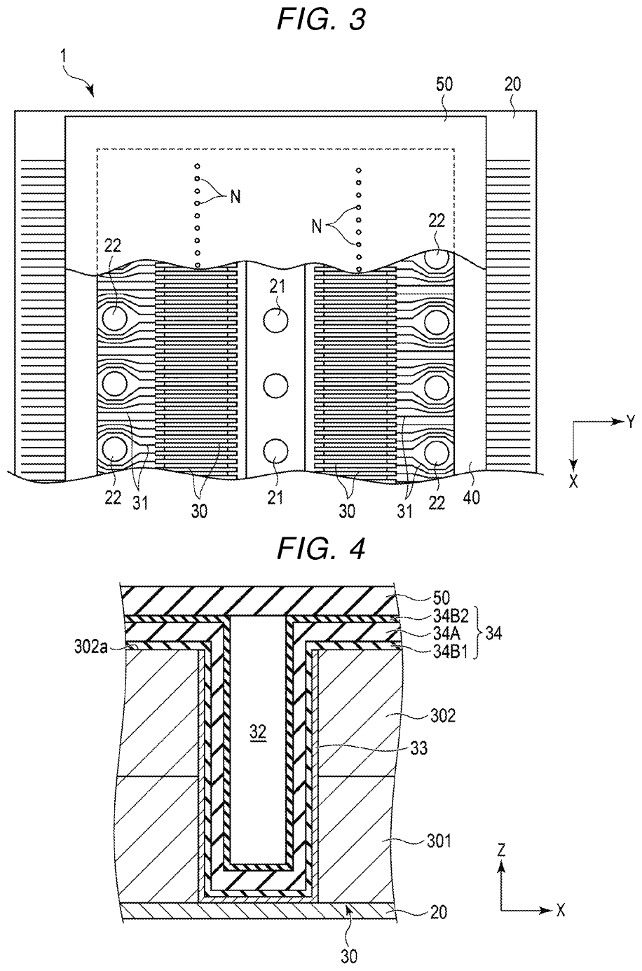

FIG. 2 illustrates an exploded perspective view of the actuator plate 20, the frame 40, and the nozzle plate 50 included in the ink jet head according to the embodiment. FIG. 3 illustrates a partially cut top view of the ink jet head according to the embodiment. FIG. 4 illustrates a cross-sectional view along a plane perpendicular to the Y-axis in FIG. 3, illustrating a part of the ink jet head according to the embodiment.

This ink jet head 1 is a side-shooter type of a so-called shear mode shared-wall.

As illustrated in FIGS. 2 and 3, in the actuator plate 20, a plurality of ink supply ports 21 are provided at intervals along the X-axis direction so as to form a row at a central portion in the Y-axis direction. In the actuator plate 20, a plurality of ink discharge ports 22 are provided at intervals along the X-axis direction so as to respectively form rows in the plus Y-axis direction and the minus Y-axis direction with respect to the row of ink supply ports 21.

A plurality of piezoelectric members 30 are provided between the row of ink supply ports 21 provided at the central portion and one row of ink discharge ports 22. These piezoelectric members 30 form a row extending in the X-axis direction. The plurality of piezoelectric members 30 are also provided between the row of ink supply ports 21 provided at the central portion and the other row of ink discharge ports 22. These piezoelectric members 30 also form a row extending in the X-axis direction.

As illustrated in FIG. 4, each of the rows of the plurality of piezoelectric members 30 includes a first piezoelectric body 301 and a second piezoelectric body 302 laminated on the actuator plate 20. Examples of the material of the first piezoelectric body 301 and the second piezoelectric body 302 include lead zirconate titanate (PZT), lithium niobate (LiNbO₃), and lithium tantalate (LiTaO₃). The first piezoelectric body 301 and the second piezoelectric body 302 are polarized in opposite directions along the thickness direction.

In a laminate of the first piezoelectric body 301 and the second piezoelectric body 302, a plurality of grooves each extending in the Y-axis direction and arranged in the X-axis direction are provided. These grooves are opened on the second piezoelectric body 302 side, and have a depth larger than the thickness of the second piezoelectric body 302. Hereinafter, portions of the laminate that are sandwiched between adjacent grooves are referred to as channel walls. Each of these channel walls extends in the Y-axis direction and is arranged in the X-axis direction.

The piezoelectric member 30 forms a plurality of pressure chambers 32 at positions communicating with nozzles N, which are described below, and are configured to eject ink from the pressure chambers 32 by changing pressure in the pressure chambers 32. Each pressure chamber 32 through which ink circulates is a space positioned in a groove between two adjacent channel walls. The width of the pressure chamber 32, here, the dimension along the X-axis direction of the pressure chamber 32 is preferably in the range of 100 μm to 300 μm, and more preferably in the range of 20 μm to 60 μm.

An electrode 33 is formed on the side walls and the bottom of each of the pressure chambers 32. That is, the electrode 33 is formed on a portion of the piezoelectric member 30 adjacent to the pressure chamber 32. These electrodes 33 are connected to wiring patterns 31 extending along the Y-axis direction. The electrode 33 applies the drive pulse to the corresponding portion of the piezoelectric member 30.

An electrode protective film 34 is formed on the surface of the actuator plate 20 including the electrode 33 and a wiring pattern 31 except for a connection portion at which a flexible printed board is connected. The electrode protective film 34 may be also referred to as an electrode protective lamination layer. The electrode protective film 34 will be described in detail below.

The frame 40 has an opening as illustrated in FIGS. 2 and 3. The opening is smaller than the actuator plate 20 and larger than a region of the actuator plate 20 where the ink supply port 21, the piezoelectric member 30, and the ink discharge port 22 are provided. The frame 40 is made of ceramics, for example. The frame 40 is joined to the actuator plate 20 by an adhesive, for example.

The nozzle plate 50 includes a nozzle plate substrate and a liquid repellent film provided on the medium facing surface (ejection surface for ejecting ink from the nozzles N). The nozzle plate substrate is made of, for example, a resin film such as a polyimide film. The liquid repellent film may be omitted.

The nozzle plate 50 is larger than the opening of the frame 40. The nozzle plate 50 is joined to the frame 40 by an adhesive, for example.

In the nozzle plate 50, a plurality of nozzles N that can eject ink toward the recording medium are provided. These nozzles N form two rows corresponding to the pressure chambers 32. The nozzle N has a diameter that increases from the recording medium facing surface toward the pressure chamber 32. The dimension of the nozzle N is set to a predetermined value according to an ink ejection amount. The nozzle N can be formed, for example, by performing laser machining using an excimer laser.

The actuator plate 20, the frame 40, and the nozzle plate 50 are integrated as illustrated in FIG. 1, and form a hollow structure. A region surrounded by the actuator plate 20, the frame 40, and the nozzle plate 50 is an ink circulation chamber. Ink is circulated in such a way that ink is supplied from the ink manifold 10 to the ink circulation chamber through the ink supply port 21, passes through the pressure chamber 32, and excess ink returns from the ink discharge port 22 to the ink manifold 10. A part of the ink is ejected from the nozzle N while flowing through the pressure chamber 32 and is used for printing.

A flexible printed board 60 is connected to the wiring pattern 31 at a position outside the frame 40 on the actuator plate 20. A drive circuit 61 that drives the piezoelectric member 30 is mounted on the flexible printed board 60.

As illustrated in FIG. 4, the electrode protective film 34 includes a portion covering the electrode 33 and a portion of the surface of the second piezoelectric body 302 that covers a region 302a not covered by the electrode 33. The latter portion can be omitted.

The electrode protective film 34 includes an insulating layer 34A, a first oxide layer 34B1, and a second oxide layer 34B2. The electrode protective film 34 is a film having a three-layer structure in which the first oxide layer 34B1, the insulating layer 34A, and the second oxide layer 34B2 are laminated in this order in the thickness direction.

The insulating layer 34A includes a portion facing the electrode 33 via the first oxide layer 34B1 and a portion facing the region 302a. The latter portion can be omitted.

The insulating layer 34A contains an organic substance. The insulating layer 34A preferably has a higher withstand voltage than the first oxide layer 34B1 and the second oxide layer 34B2. The insulating layer 34A preferably has a lower moisture vapor transmission rate than the first oxide layer 34B1 and the second oxide layer 34B2.

The organic substance preferably contains a compound having a polyparaxylylene backbone. According to an example, the insulating layer 34A is made of the compound having a polyparaxylylene backbone.

The compound having the polyparaxylylene backbone preferably contains a repeating unit represented by the following general chemical formula (I):

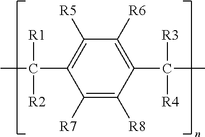

In the general chemical formula (I), each of R1 to R8 independently represents a hydrogen atom or a halogen atom. Preferably, R1 to R4 are a hydrogen atom or a fluorine atom, and R5 to R8 are a hydrogen atom or a chlorine atom.

The compound having a polyparaxylylene backbone preferably comprises a compound in which, in the general chemical formula (I), all of R1 to R8 are hydrogen atoms or a compound in which R1 to R4 are hydrogen atoms, any one of R5 to R8 is a chlorine atom, and the other atoms of R5 to R8 are hydrogen atoms. That is, the insulating layer 34A is preferably polyparaxylylene or polymonochloroparaxylylene. More preferably, the insulating layer 34A comprises only polymonochloroparaxylylene. An example of the compound constituting the insulating layer 34A includes diX® (manufactured by KISCO).

The thickness of the insulating layer 34A is preferably between 1 μm and 15 μm, and more preferably between 5 μm and 10 μm. The thickness of the insulating layer 34A can be measured, for example, by observing a cross-section in a scanning electron microscope (SEM). When the thickness of the insulating layer 34A is increased, insulation durability of the ink jet head is improved. However, when the insulating layer 34A is excessively thick, operation of the piezoelectric member 30 may be hindered.

The first oxide layer 34B1 includes a portion positioned between the electrode 33 and the insulating layer 34A and a portion positioned between the region 302a and the insulating layer 34A. The latter portion can be omitted in some examples.

The oxygen content of the first oxide layer 34B1 is greater than the oxygen content of the insulating layer 34A. Here, the “oxygen content” represents an amount of oxygen per unit volume. Whether the oxygen content of the first oxide layer 34B1 is greater than the oxygen content of the insulating layer 34A can be confirmed by X-ray photoelectron spectroscopy (XPS) analysis, for example. Specifically, the ink jet printer is disassembled and the electrode protective film 34 is collected. The XPS analysis is performed while etching the collected electrode protective film 34 in the thickness direction, thereby obtaining an O1s spectrum. A difference in oxygen content between the oxide layer and the insulating layer can be confirmed from a plurality of O1s spectra in the thickness direction.

The first oxide layer 34B1 includes, for example, an oxide of a metal or non-metallic element. The metal or non-metallic element is preferably at least one element selected from a group consisting of silicon (Si), titanium (Ti), aluminum (Al), hafnium (Hf), and tantalum (Ta). The oxide of the metal or non-metallic element preferably contains at least one oxide selected from a group consisting of SiO₂, Al₂O₃, TiO₂, HfO₂, and Ta₂O₅. From the viewpoint of improving the adhesion with the electrode 33, the oxide preferably contains at least one oxide selected from a group consisting of SiO₂, Al₂O₃, and TiO₂.

More preferably, the first oxide layer 34B1 includes SiO₂. Since SiO₂ has a higher atomic ratio of oxygen than the other oxides exemplified above, SiO₂ is particularly good in increasing the insulation durability of the ink jet head. Since a dielectric constant of SiO₂ is small, parasitic capacitance can be reduced by using SiO₂. Furthermore, when SiO₂ is used, a film having excellent flexibility can be obtained at low cost.

The thickness of the first oxide layer 34B1 is preferably 10 nm to 1000 nm. The thickness of the first oxide layer 34B1 is more preferably 100 nm to 500 nm. When the thickness of the insulating layer 34A is increased, the insulation durability of the ink jet head is improved. However, when the insulating layer 34A is excessively thickened, the operation of the piezoelectric member 30 may be hindered. The thickness of the first oxide layer 34B1 can be measured, for example, by observing a cross-section with the SEM.

The first oxide layer 34B1 may be an oxide film made of an oxide of the material of the insulating layer 34A. The thickness of the first oxide layer 34B1 is preferably in the range of 10 nm or to 100 nm, and more preferably in the range of 20 nm to 60 nm. When the thickness of the surface region is too large, early insulation of the electrode protective film may be insufficient. When the thickness of the surface region is too small, long-term insulation may be insufficient.

The second oxide layer 34B2 covers the insulating layer 34A. The second oxide layer 34B2 includes a portion positioned between the insulating layer 34A and the pressure chamber 32 and a portion positioned between the insulating layer 34A and the nozzle plate 50. The latter portion can be omitted.

The second oxide layer 34B2 includes, for example, an oxide of a metal or non-metallic element. As the metal or non-metallic element and the oxide thereof, the same element and oxide as those described for the first oxide layer 34B1 can be used. From the viewpoint of excellent ink resistance, the second oxide layer 34B2 preferably contains at least one oxide selected from a group consisting of HfO₂ and Ta₂O₅.

The thickness of the second oxide layer 34B2 is preferably within the range described above for the first oxide layer 34B1.

The second oxide layer 34B2 may be an oxide film formed by oxidizing the surface region of the insulating layer 34A. That is, the second oxide layer 34B2 may be an oxide film made of an oxide of the material of the insulating layer 34A. The film thickness of the second oxide layer 34B2 is preferably within the range described above for the first oxide layer 34B1 made of the oxide of the material of the insulating layer 34A.

One of the first oxide layer 34B1 and the second oxide layer 34B2 may be omitted.

### 1-2. Ink Ejection

Hereinafter, the operation of the piezoelectric member 30 will be described with reference to FIGS. 3 and 4. Here, the operation will be described assuming that the pressure chambers 32 are also formed on both sides of the central pressure chamber 32. It is assumed that the electrodes 33 corresponding to the three adjacent pressure chambers 32 are electrodes A, B and C, respectively, and the electrode 33 corresponding to the central pressure chamber 32 is the electrode B.

In order to eject ink from the nozzle N, first, for example, a voltage pulse having higher potential than potentials of the adjacent electrodes A and C is applied to the central electrode B to generate an electric field in a direction perpendicular to the channel wall. Thus, the channel walls are driven in the shear mode and a pair of channel walls sandwiching the central pressure chamber 32 is deformed so that the central pressure chamber 32 expands.

Next, a voltage pulse having higher potential than the potential of the central electrode B is applied to both adjacent electrodes A and C to generate an electric field in a direction perpendicular to the channel wall. Thus, the channel walls are driven in the shear mode and the pair of channel walls sandwiching the central pressure chamber 32 is deformed so that the central pressure chamber 32 is reduced. By this operation, pressure is applied to ink in the central pressure chamber 32 and the ink is ejected from the nozzle N corresponding to the pressure chamber 32 to land on the recording medium. Thus, in the ink jet head 1, ink is ejected from the nozzle N using the piezoelectric member 30 as an actuator.

In the printing process using the ink jet head 1, for example, all the nozzles N are divided into three groups and the driving operation described above is performed in a time-sharing manner for three cycles to perform printing on the recording medium.

### 1-3. Manufacturing Method

Next, a method for manufacturing the ink jet head 1 illustrated in FIGS. 1 to 4 will be described.

The ink jet head 1 is manufactured by the following method. First, a structure including the piezoelectric member 30 and the electrode 33 is formed. Specifically, a structure including the piezoelectric member 30 that forms the pressure chamber 32 to which ink is supplied and ejects ink in the pressure chamber 32 by changing the pressure in the pressure chamber 32, and the electrode 33 that is positioned in a portion of the piezoelectric member 30 adjacent to the pressure chamber 32 and applies the drive pulse to the piezoelectric member 30 is formed. The structure can be formed by a method known in the related art.

Next, the electrode protective film 34 is formed on the electrode 33 and the region 302a by a method described below. Thereafter, the nozzle plate 50 is installed so that the nozzle N communicates with the pressure chamber 32.

An example of a method for manufacturing the electrode protective film 34 will be described.

First, the first oxide layer 34B1 is formed on the electrode 33 and the region 302a. For example, first, dispersion liquid in which transition element oxide particles are dispersed in a dispersion medium is prepared. As the dispersion medium, water or an organic solvent may be used. The dispersion liquid may further contain a binding agent. Next, this dispersion liquid is coated onto the electrode 33 and the region 302a by using, for example, a spin coat method, a spray method, or the like to form a coating film. This coating film is dried to obtain the first oxide layer 34B1. The first oxide layer 34B1 may be formed by a sol-gel method.

The first oxide layer 34B1 may be formed by a chemical vapor deposition (CVD) method. When the SiO₂ film is used as the first oxide layer 34B1, it is preferable to use a plasma-enhanced chemical vapor deposition (PECVD) method using tetraethyl orthosilicate (TEOS) as a raw material. When the PECVD method is used, production efficiency can be increased.

Next, the insulating layer 34A is formed on the first oxide layer 34B1. Specifically, first, an organic substance is prepared. As the organic substance, for example, a compound having a polyparaxylylene skeleton can be used. The organic substance is deposited on the first oxide layer 34B1 by using a method known in the related art such as a vapor deposition method to form the insulating layer 34A.

Next, the second oxide layer 34B2 is formed on the insulating layer 34A. For example, the second oxide layer 34B2 is obtained by oxidizing the surface of the insulating layer 34A. Examples of the method for oxidizing the surface of the insulating layer 34A include ultraviolet irradiation treatment, plasma treatment, and ozone treatment in an oxygen-containing atmosphere. From the viewpoint that the insulating layer 34A is hardly deteriorated, it is preferable to use an ultraviolet irradiation treatment as a surface treatment method of the insulating layer 34A. In the ultraviolet irradiation, the illuminance is preferably 10 mW/cm² to 20 mW/cm², and the irradiation time is 3 to 10 minutes.

Alternatively, the second oxide layer 34B2 may be formed by a method similar to that of the first oxide layer 34B1.

Next, another example of the method for manufacturing the electrode protective film 34 will be described.

First, a layer made of the same material as the insulating layer 34A is formed on a base material. For formation of this layer, the same method as described above for the insulating layer 34A can be used. Next, this layer is oxidized to obtain the first oxide layer 34B1.

Next, the insulating layer 34A is formed on the first oxide layer 34B1. The insulating layer 34A can be formed by the same method as described above. Thereafter, the surface region of the insulating layer 34A is oxidized to obtain the second oxide layer 34B2.

Although the method for forming the electrode protective film 34 having a three-layer structure is described here, the electrode protective film 34 having a two-layer structure may be formed by omitting the formation of the first oxide layer 34B1 or the second oxide layer 34B2.

### 2. Ink Jet Printer

### 2.1 Configuration

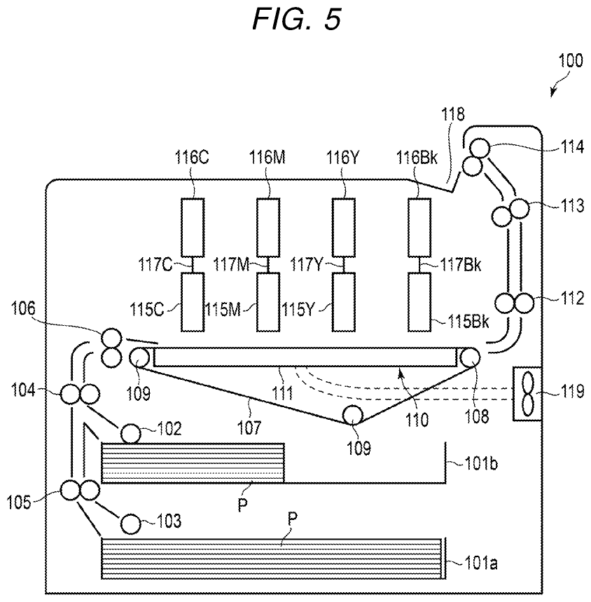

FIG. 5 illustrates a schematic diagram of an ink jet printer 100.

The ink jet printer 100 according to the embodiment includes ink jet heads 115C, 115M, 115Y, and 115Bk, and a medium holding mechanism 110 that holds the recording medium facing the ink jet heads 115C, 115M, 115Y, and 115Bk. Each of the ink jet heads 115C, 115M, 115Y, and 115Bk is the ink jet head 1 described with reference to FIGS. 1 and 2.

The ink jet printer 100 illustrated in FIG. 5 includes a casing including a paper discharge tray 118. In the casing, cassettes 101a and 101b, paper feed rollers 102 and 103, conveyance roller pairs 104 and 105, a registration roller pair 106, a conveyance belt 107, a fan 119, a negative pressure chamber 111, conveyance roller pairs 112, 113 and 114, ink jet heads 115C, 115M, 115Y, and 115Bk, ink cartridges 116C, 116M, 116Y, and 116Bk, and tubes 117C, 117M, 117Y, and 117Bk are installed.

The cassettes 101a and 101b accommodate recording media P of different sizes. The paper feed roller 102 or 103 picks up the recording medium P corresponding to the size of a selected recording medium from the cassette 101a or 101b and conveys the recording medium P to the conveyance roller pairs 104 and 105 and the registration roller pair 106.

The conveyance belt 107 is tensioned by a driving roller 108 and two driven rollers 109. Holes are provided on the surface of the conveyance belt 107 at predetermined intervals. The negative pressure chamber 111 connected to the fan 119 for holding the recording medium P to the conveyance belt 107 is installed inside the conveyance belt 107. The conveyance roller pairs 112, 113, and 114 are installed downstream of the conveyance belt 107 in the conveyance direction. A heater for heating a printed layer formed on the recording medium P can be installed in a conveyance path from the conveyance belt 107 to the paper discharge tray 118.

Above the conveyance belt 107, four ink jet heads that eject ink onto the recording medium P according to image data are disposed. Specifically, an ink jet head 115C that ejects cyan (C) ink, an ink jet head 115M that ejects magenta (M) ink, an ink jet head 115Y that ejects yellow (Y) ink, and an ink jet head 115Bk that ejects black (Bk) ink are disposed in this order from the upstream side. Each of the ink jet heads 115C, 115M, 115Y, and 115Bk is the ink jet head 1 described with reference to FIGS. 1 and 2.

Above the ink jet heads 115C, 115M, 115Y, and 115Bk, a cyan (C) ink cartridge 116C, a magenta (M) ink cartridge 116M, a yellow (Y) ink cartridge 116Y, and a black (Bk) ink cartridge 116Bk that respectively contain inks corresponding to the ink jet heads 115C, 115M, 115Y, and 115Bk are installed. These ink cartridges 116C, 116M, 116Y, and 116Bk are connected to the ink jet heads 115C, 115M, 115Y, and 115Bk by the tubes 117C, 117M, 117Y, and 117Bk, respectively.

### 2-2. Image Formation

Next, an image forming operation of the ink jet printer 100 will be described.

First, an image processing unit starts image processing, generates an image signal corresponding to image data, and generates a control signal for controlling operations of various rollers, the negative pressure chamber 111, and the like.

Under the control of the image processing unit, the paper feed roller 102 or 103 picks up the recording medium P of the selected size from the cassette 101a or 101b and conveys the recording medium P to the conveyance roller pair 104 or 105 and the registration roller pair 106. The registration roller pair 106 corrects skew of the recording medium P and conveys the recording medium P at a predetermined timing.

The negative pressure chamber 111 suctions air through the holes of the conveyance belt 107. Accordingly, the recording medium P is sequentially conveyed to positions below the ink jet heads 115C, 115M, 115Y, and 115Bk as the conveyance belt 107 moves in a state of being attracted to the conveyance belt 107.

The ink jet heads 115C, 115M, 115Y, and 115Bk eject ink in synchronization with the timing at which the recording medium P is conveyed under the control of the image processing unit. With this configuration, a color image is formed at a desired position on the recording medium P.

Thereafter, the conveyance roller pairs 112, 113, and 114 discharge the recording medium P on which the image is formed to the paper discharge tray 118. When a heater is installed in the conveyance path from the conveyance belt 107 to the paper discharge tray 118, the print layer formed on the recording medium P may be heated by the heater. When heating with the heater is performed, particularly when the recording medium P is impermeable, adhesion of the print layer to the recording medium P can be improved.

### 3. Effect

The ink jet head 1 described above includes the electrode protective film 34 in which the first oxide layer 34B1 and the second oxide layer 34B2 each having a higher oxygen content than that of the insulating layer 34A are laminated on both surfaces of the insulating layer 34A. According to such a configuration, excellent insulation durability can be achieved. The reason will be described below.

One of the possible reasons why an ink jet head that does not include the first oxide layer 34B1 and the second oxide layer 34B2, may not achieve insulation durability is that organic molecules on the electrode are destroyed in the insulating layer covering the electrode. Such destruction is considered to be caused by the following reason.

In the shear mode type ink jet head, an AC voltage is applied to the piezoelectric member. Accordingly, an AC voltage is also applied to an electrode used for applying a voltage to the piezoelectric element, and inks are adjacent to the electrode with the insulating layer interposed therebetween. That is, both the electrode and the ink can be an anode or a cathode.

In this case, in the region of the insulating layer in contact with the anode, electrons are separated from the organic molecules contained in the insulating layer, and the separated electrons may move to the anode. In the portion where the electrons are separated in the insulating layer, vacancies, that is, holes formed by escape of electrons, are formed (hole injection). When such a movement of electrons is repeated and then ultimately exceeds a certain amount, destruction of the organic molecules constituting the insulating layer occur in a region near the anode. As a result, it is considered that dielectric breakdown occurs in the insulating layer.

In the ink jet head 1 according to the embodiment, the first oxide layer 34B1 and the second oxide layer 34B2 having a higher oxygen content than that of the insulating layer 34A are disposed between the electrode 33 and the insulating layer 34A and between the ink and the insulating layer 34A, respectively. That is, in the ink jet head 1, the first oxide layer 34B1 or the second oxide layer 34B2 is interposed between the insulating layer 34A and the anode. Oxygen has a relatively large electronegativity. For that reason, the first oxide layer 34B1 and the second oxide layer 34B2 more easily donate electrons to the anode than the insulating layer 34A. Accordingly, when the first oxide layer 34B1 and second oxide layer 34B2 are in contact with the anode, hole injection into the insulating layer 34A can be suppressed. Therefore, it is more difficult to cause dielectric breakdown due to deterioration of the insulating layer 34A.

As described above, both the electrode 33 and the ink can be an anode and a cathode. Accordingly, as described above, it is preferable to dispose the first oxide layer 34B1 and the second oxide layer 34B2 between the electrode 33 and the insulating layer 34A and between the ink and the insulating layer 34A, respectively. However, even when one of the first oxide layer 34B1 and the second oxide layer 34B2 is omitted, it is still possible to make it somewhat more difficult to cause dielectric breakdown due to deterioration of the insulating layer 34A as compared to the case where both the first oxide layer 34B1 and the second oxide layer 34B2 are omitted.

Either one of the first oxide layer 34B1 and the second oxide layer 34B2 may be omitted in some examples. However, it is generally preferable not to omit the first oxide layer 34B1. This is because movement of electrons to the electrode 33 is easier to occur than movement of electrons to the ink

### EXAMPLES

### Ink Jet Head Manufacturing

### Example 1

The ink jet head 1 illustrated in FIGS. 1 to 4 was manufactured as follows.

First, a structure including the piezoelectric member 30 and the electrode 33 was formed. Next, the insulating layer 34A and the second oxide layer 34B2 were laminated on the electrode 33 in this order.

Specifically, a film made of polyparaxylylene (Parylene® C) was formed on the electrode 33 by a vapor deposition method to obtain the insulating layer 34A. The thickness of the insulating layer 34A was 5 μm.

Next, an ethanol solution containing the TEOS was coated onto the insulating layer 34A by a spin coating method to form a coating film. This coating film was dried at room temperature to obtain a SiO₂ film as the second oxide layer 34B2. The film thickness of the second oxide layer 34B2 was 0.5 μm.

Subsequently, the nozzle plate 50 was installed so that the nozzle N communicated with the pressure chamber 32, and the ink jet head 1 was obtained.

### Example 2

Instead of forming the SiO₂ film as the second oxide layer 34B2, the surface region of the insulating layer 34A was irradiated with ultraviolet rays to form an oxide film. Other than this, the ink jet head 1 was obtained in the same manner as in Example 1. In the ultraviolet irradiation, the illuminance was 17 mW/cm² and the irradiation time was 5 minutes. The film thickness of the second oxide layer 34B2 was 30 nm.

### Example 3

The ink jet head 1 was obtained in the same manner as in Example 1 except that the first oxide layer 34B1 was provided prior to formation of the insulating layer 34A. The first oxide layer 34B1 was formed on the electrode 33 in the same manner as the second oxide layer 34B2 of Example 1. The film thickness of the first oxide layer 34B1 was 1 μm.

### Comparative Example 1

An ink jet head was obtained in the same manner as described in Example 1 except that the formation of the second oxide layer 34B2 was omitted.

### Evaluation

A voltage was applied to the electrode 33 of the ink jet head obtained in the Examples and Comparative Example, and a leakage current value was observed. Specifically, first, a voltage pulse having an amplitude of 60 V was applied to the electrode 33 of the ink jet head 1×10⁸ times. Thereafter, current leakage between the electrode 33 and the ink was measured. The same measurement was performed on the ink jet head to which the voltage pulse was applied 1×10⁹ times, 1×10¹⁰ times, 1×10¹¹ times, and 1×10¹² times.

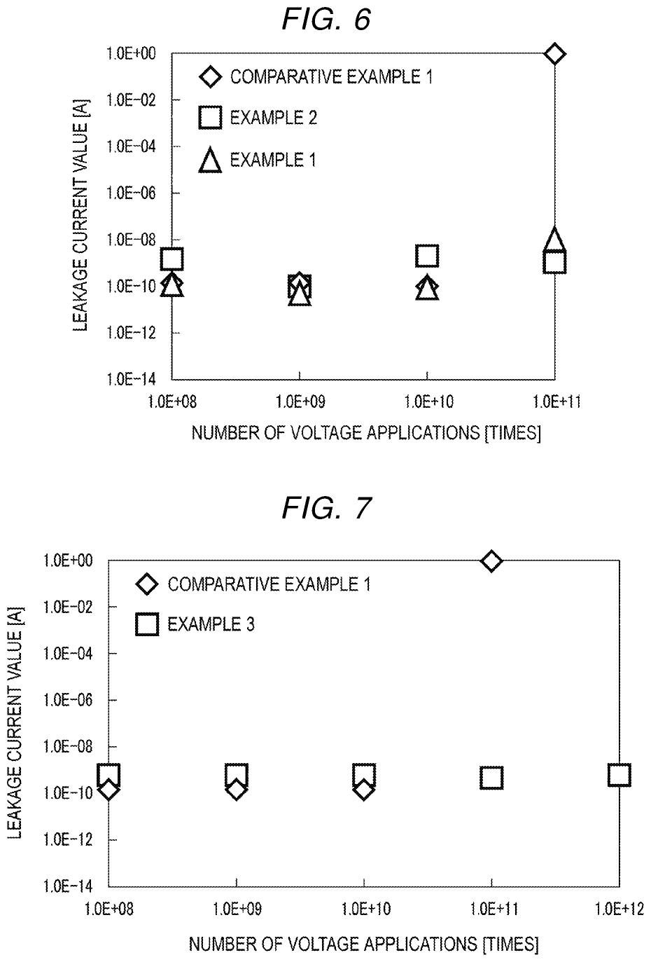

The results of Examples 1 and 2 and Comparative Example 1 are illustrated in FIG. 6. FIG. 6 is a graph illustrating an example of the relationship of a leakage current value of the electrode protective film to the number of times the voltage pulse is applied.

As illustrated in FIG. 6, in the ink jet head according to Comparative Example 1, the leak current value was significantly increased by applying the voltage 1×10¹¹ times or more. On the other hand, in the ink jet heads according to Examples 1 and 2, the leakage current value did not change even when the voltage application was repeated 1×10¹¹ times. That is, excellent insulation durability was achieved in Examples 1 and 2. When the SiO₂ film was used as the second oxide layer 34B2, a fact that the leakage current value was smaller and the insulation durability was more excellent was exhibited than when an UV treatment film of the parylene film was used as the second oxide layer 34B2.

The results of Example 3 and Comparative Example 1 are illustrated in FIG. 7. FIG. 7 is a graph illustrating another example of the relationship of the leakage current value of the electrode protective film to the number of times the voltage pulse is applied.

As illustrated in FIG. 7, in the ink jet head according to Example 3, the leak current value did not change even when the voltage application was repeated 1×10¹² times. That is, excellent insulation durability was achieved in Example 3. The insulation durability of the inkjet head according to Example 3 using the electrode protective film having the three-layer structure of the first oxide layer, the insulating layer, and the second oxide layer was superior to the insulation durability of the ink jet heads according to Examples 1 and 2 using the electrode protective film having a two-layer structure of the insulating layer and the second oxide layer.

An ink jet head according to example embodiments described above includes an insulating protective film in which an insulating layer and an oxide layer having a higher oxygen content than that of the insulating layer are laminated on each other. Accordingly, an ink jet head according to an example embodiment can maintain insulation for a long period of time.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An ink jet head, comprising:
a piezoelectric member having a plurality of grooves;
a plurality of electrodes provided along the grooves;
a protective lamination layer on the electrodes; and
a nozzle plate on the piezoelectric member and having a plurality of ejection nozzles that face the plurality of grooves, wherein
the protective lamination layer includes an insulating layer laminated to a first oxide layer,
the insulating layer comprises an organic material, and
an oxygen content of the first oxide layer is greater than an oxygen content of the insulating layer.

2. The ink jet head according to claim 1, wherein the first oxide layer comprises at least one of silicon, titanium, aluminum, hafnium, and tantalum.

3. The ink jet head according to claim 1, wherein the organic material comprises a polymeric material with a polyparaxylylene backbone.

4. The ink jet head according to claim 1, wherein the first oxide layer is between the insulating layer and a surface of the electrodes.

5. The ink jet head according to claim 4, wherein
the protective lamination layer further includes a second oxide layer on a surface of the insulating layer opposite to a surface on which the first oxide layer is laminated,
an oxygen content of the second oxide layer is greater than the oxygen content of the insulating layer.

6. The ink jet head according to claim 5, wherein a moisture vapor transmission rate of the insulating layer is lower than a moisture vapor transmission rate of the first oxide layer and a moisture vapor transmission rate of the second oxide layer.

7. The ink jet head according to claim 5, wherein a thickness of the insulating layer is greater than a thickness of the first oxide layer and a thickness of the second oxide layer.

8. The ink jet head according to claim 1, wherein the insulating layer is between the first oxide layer and the electrodes.

9. The ink jet head according to claim 1, wherein a moisture vapor transmission rate of the insulating layer is lower than a moisture vapor transmission rate of the first oxide layer.

10. The ink jet head according to claim 1, wherein a thickness of the insulating layer is greater than a thickness of the first oxide layer.

11. A printer, comprising:
a media conveyer configured to convey a medium; and
an ink jet head configured to eject ink onto the medium conveyed by the media conveyer, the ink jet head comprising:
a piezoelectric member having a plurality of grooves;
a plurality of electrodes provided along the grooves;
a protective lamination layer on the electrodes; and
a nozzle plate on the piezoelectric member and having a plurality of ejection nozzles that face the plurality of grooves, wherein
the protective lamination layer includes an insulating layer laminated to a first oxide layer,
the insulating layer comprises an organic material, and
an oxygen content of the first oxide layer is greater than an oxygen content of the insulating layer.

12. The printer according to claim 11, wherein the first oxide layer comprises at least one of silicon, titanium, aluminum, hafnium, and tantalum.

13. The printer according to claim 11, wherein organic material comprises a polymeric material with a polyparaxylylene backbone.

14. The printer according to claim 11, wherein the first oxide layer is between the insulating layer and a surface of the electrodes.

15. The printer according to claim 14, wherein
the protective lamination layer further includes a second oxide layer on a surface of the insulating layer opposite to a surface on which the first oxide layer is laminated,
an oxygen content of the second oxide layer is greater than the oxygen content of the insulating layer.

16. The printer according to claim 15, wherein a moisture vapor transmission rate of the insulating layer is lower than a moisture vapor transmission rate of the first oxide layer and a moisture vapor transmission rate of the second oxide layer.

17. The printer according to claim 15, wherein a thickness of the insulating layer is greater than a thickness of the first oxide layer and a thickness of the second oxide layer.

18. The printer according to claim 11, wherein the insulating layer is between the first oxide layer and the electrodes.

19. The printer according to claim 11, wherein a moisture vapor transmission rate of the insulating layer is lower than a moisture vapor transmission rate of the first oxide layer.

20. The printer according to claim 11, wherein a thickness of the insulating layer is greater than a thickness of the first oxide layer.
